(19) United States
(12) Patent Application Publication
(10) Pub. No.: US 2004/0203310 A1
(43) Pub. Date: Oct. 14, 2004

(54) Protective garment against molten metal

(75) Inventors: Shigeyoshi Watanabe, Ehime (JP); Manabu Watanabe, Ehime (JP)

Correspondence Address: SUGHRUE MION, PLLC, 2100 PENNSYLVANIA AVENUE, N.W., SUITE 800, WASHINGTON, DC, 20037, US

(73) Assignee: TEIJIN LIMITED

(21) Appl. No.: 10/834,049

(22) Filed: Apr. 29, 2004

(30) Foreign Application Priority Data
Nov. 7, 2002 (JP) P2002-323836

(51) Int. Cl. B32B 3/00; D03D 25/00; D04H 13/00; D04H 1/00; B32B 9/04; B32B 27/38; D04H 3/00; B32B 5/26

(52) U.S. Cl. 442/414; 442/354; 442/381; 442/389; 428/411.1; 428/414

(57) ABSTRACT

A protective garment for protection molten metals is provided with a laminated fabric including a surface layer of an heat-resistant fabric, an intermediate layer of a carbon fabric, one or more heat insulating layers of non-woven heat-resistant fabrics laminated inside of the intermediate layer and a lining of an heat-resistant fabric configured to be moisture-absorbing.

### BACKGROUND OF THE INVENTION

1. Field of the Invention

The present invention relates to protective garments for use in work with molten metal such as steelmaking, refining or thermal cutting and, more particularly, to protective garments capable of safely receiving occasional splashes of molten metal having large weight and high temperature and preventing penetration of the molten metal therethrough as well as being flexible and light for ease of work.

2. Description of the Related Art

Though various types of furnace-side work in steel companies have been mechanized in recent years, handwork by skilled workers is still necessary. Such workers might encounter high temperatures and occasional splashes of molten metal and hence require protective garments.

Protective garments are conventionally made of asbestos, organic fibers and inorganic fibers such as rock wool, glass fiber, silica cloth. Among them, asbestos has good performance in view of heat-resistance, flexibility and lightness, however, is now prohibited by law because asbestos dust is unfavorable for health. Organic fibers do not have enough heat-resistance because the molten metal having temperatures up to 1500° C. decomposes the organic fibers. Rock wool has a relatively low melting point and is hence softened at 650° C. Once being softened, the protective garments lose flexibility. Glass fiber has lower softening point than the rock wool. Silica cloth, which had been developed as a heat-resistant sheet, is resistant against high temperatures up to 1000° C., however, is embrittled and fracted at 1500° C.

Japanese Patent Application Laid-open No. H07-189039 discloses silicon carbide fibers, which have high heat-resistance, high strength and high resistance against oxidation. However, such silicon carbide fibers are so fragile to be easily broken when being scratched and therefore are not adapted for making any fabrics. Furthermore, silicon carbide is a good conductor of heat and therefore fabrics made of silicon carbide fibers do not protect the workers against heat.

As being understood from the above description, any satisfactory alternative to protective garments made of asbestos, which have heat-resistance against molten metal having temperatures up to 1500° C., had not been developed.

### SUMMARY OF THE INVENTION

The present invention is intended for providing a garment for protection against molten metals, to which carbon fabric is applied.

According to a first aspect of the present invention, a laminated fabric for a protective garment is provided with a surface layer of a heat-resistant fabric, an intermediate layer of a carbon fabric, one or more heat insulating layers of non-woven heat-resistant fabrics laminated inside of the intermediate layer and a lining of an heat-resistant fabric configured to be moisture-absorbing.

According to a second aspect of the present invention, a protective garment for protection molten metals is provided with a laminated fabric including a surface layer of a heat-resistant fabric, an intermediate layer of a carbon fabric, one or more heat insulating layers of non-woven heat-resistant fabrics laminated inside of the intermediate layer and a lining of an heat-resistant fabric configured to be moisture-absorbing.

Preferably, the heat-resistant fabric and the non-woven heat-resistant fabric are consisting essentially of aramid. More preferably, the surface layer is coated with aluminum powder. Still preferably, the carbon fabric is a carbonization product of a fabric of acrylic fiber. Further preferably, the carbon fabric is heat-resistant against 1500° C. Still further preferably, total thickness of the heat insulating layers and the lining is 2 mm or greater.

### BRIEF DESCRIPTOIN OF THE DRAWING

FIG. 1 is an illustration of a fabric for a protective garment according to an embodiment of the present invention, in a state of bending the fabric;

FIG. 2 is a schematic illustration of evaluation of the fabric;

FIG. 3 is a graph of temperature change given by the evaluation shown in FIG. 2 in a case where 15 g of molten metal is dropped thereon;

FIG. 4 is a graph of temperature change given by the evaluation shown in FIG. 2 in a case where 5 g of molten metal is dropped thereon;

FIG. 5 is a front view of a protective jacket according to a version of the present invention;

FIG. 6 is a front view of pants used in combination with the jacket shown in FIG. 5;

FIG. 7 is a front view of a protective garment according to another version of the present invention; and

FIG. 8 is a rear view of the protective garment of FIG. 7.

### DETAILED DESCRIPTION OF THE PREFERRED EMBODIMENT

An embodiment of the present invention will be described hereinafter with reference to the accompanying drawings.

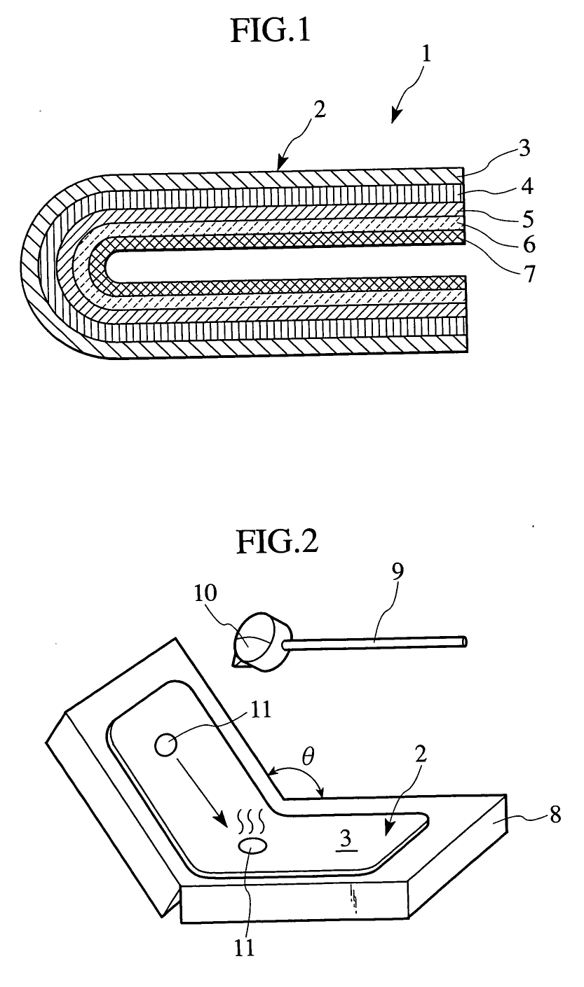

A fabric 2 for a protective garment 1 against molten metal is provided with a surface layer 3 made of aramid fabric on which aluminum powder is coated, a carbon fabric layer 4 made of a carbon fabric, a first heat insulating layer 5 made of a non-woven aramid fabric compounding carbon, a second heat insulating layer 6 made of a non-woven aramid fabric and a lining 7 made of an aramid fabric configured to be moisture-absorbing, as shown in FIG. 1.

The carbon fabric is a carbonization product of the following process. First, a fabric is woven or knit from acrylic fibers, such as polyacrylonitrile fiber, and next fired and completely carbonized at 1800 through 2000° C. in nitrogen gas. Such the carbon fabric is generally heat-resistant against 1500° C. A term “aramid” is a common name of “aromatic polyamide fiber” which generally has a high strength and a high heat-resistance. Total thickness of the first and second heat insulating layers 5 and 6 and the lining 7 is preferably 2 mm or greater. More preferably, thin (0.3 mm) layers of aramid fabric are further interposed between the surface layer 3 and the interposed layer 4 and between the second heat insulating layer 6 and the lining 7. The interposed thin layers give slidability between the layers so as to increase flexibility of the fabric 2.

The fabric 2 may be folded as shown in FIG. 1 and then strain is introduced around the folded portion of the fabric 2. However, the carbon fabric layer 4 is lined with the first and second heat insulating layer 5 and 6 and the lining 7 which have enough flexibility to absorb the strain, thereby the carbon fabric layer 4 is prevented from being broken or deterioration. In a case where the thin layers are interposed therein, the thin layers give slidability to the fabric 2 so as to further absorb the strain. Thereby the fabric 2 can be folded without deterioration.

The lining 7 is made of a moisture-absorbing aramid fabric so as to absorb sweat. Provided that the wearer sweats in a hot situation, the lining 7 absorbs his sweat so that he can work in comfort.

The surface layer 3 is coated with the aluminum powders so that heat radiation from molten metal is reflected and adhered molten metal easily flows out. The first and second heat insulating layer 5 and 6 suppress heat conduction, thereby the fabric 2 effectively prevents heat conduction from the adhered molten metal though the carbon fabric layer 4 has relatively high heat conductivity. The surface layer 3 protects the carbon fabric layer 4 from scratching so that the carbon fabric layer 4 is prevented from being broken.

[Resistance Against Molten Metal]

FIG. 2 shows an apparatus and a method of evaluation test for resistance against molten metal. A test plate 8 made of wood can be folded at a center thereof and a half thereof can be elevated in an angle θ relative to an opposite half thereof. A fabric 2 subject for the test is placed on the test plate 8 as the surface layer 3 opposed upward and molten metal 10 of iron is dropped onto the elevated half from a ladle 9. A temperature of the molten metal 10 of iron is regulated at 1550° C. After dropping, behavior of a droplet 11 of the molten iron and a fabric 2 was observed.

Sizes of the droplet 11 staying on the fabric 2 are dependent on the angle θ. When the angle θ is greater than 20 degrees, the droplets 11 larger than 1 mm in size do not stay on the fabric 2 on the elevated half. Namely, the surface layer 3 has a good property of easiness for molten metal droplet to flow out.

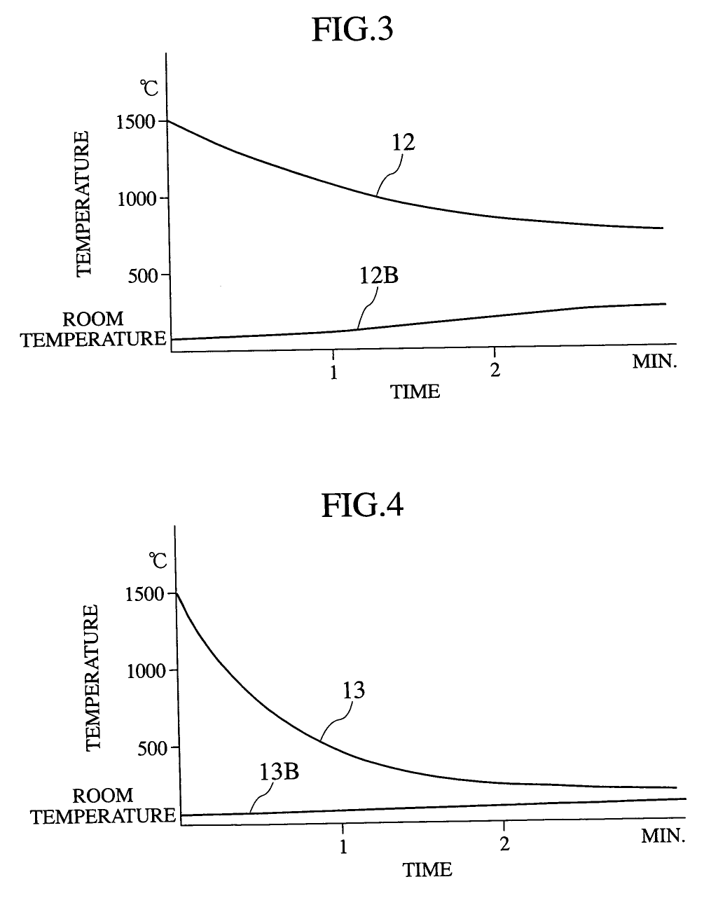

The droplet 11 was dropped on the fabric 2 placed on the horizontal test plate 8 and temperature changes of the droplet 11 and the lining 7 of the fabric 2 were measured. Test results were respectively shown in FIG. 3, in which weight of the droplet 11 was 15 g, and in FIG. 4, in which weight of the droplet 11 was 5 g. The droplets in such weights are larger than 1 mm in size as mentioned above so as not to stay on the fabric 2 at angles θ greater than 20 degrees.

Referring to FIG. 3, reference numerals 12 and 12B respectively represent temperature changes of the droplet 11 and the lining 7. It spends 5 through 6 minutes to cool the temperature of the droplet 11 to the room temperature. In the meantime, the temperature of the lining 7 rises up to about 300° C. However, the temperature is measured by a temperature sensor pressed on the lining 7 and therefore a wearer may not get burned in a practical condition. In such a severe condition, the surface layer 3 is burned and a hole is made thereon, however, the surface layer 3 does not catch fire and the hole does not penetrates the carbon fabric layer 4.

Referring to FIG. 4, reference numerals 13 and 13B respectively represent temperature changes of the droplet 11 and the lining 7. The surface layer 3 is slightly burned to be colored in brown, however, a hole is not made. The temperature of the lining 7 rises up to about 100° C., however, the heat is in an extent that warmth can be felt by a hand touching thereto.

As being understood from the test results shown in FIGS. 3 and 4, the protective garment 1 made from the fabric 2 according to the embodiment of the present invention can effectively protect the wearer from 5 g or 15 g of the molten metal droplets which is not thought to stay on the protective garment 1.

Suppression of temperature increase on the lining is an important factor as well as the above mentioned protection from penetration of the molten metal.

300 g of molten iron was pooled on the fabric 2 placed on the horizontal test plate 8 and a temperature change of the lining 7 of the fabric 2 was measured. Three sets of tests were examined according to three variations of the temperatures of the molten iron. Table 1 shows the test results.

Table 1 Temperature Changes After Pooling Molten Iron (° C.)

TABLE 1
temperature changes after pooling molten iron (°C.)

| | temperature of | | | | | |
|---|---|---|---|---|---|---|
| No. | molten iron | initial | 3 sec. | 5 sec. | 7 sec. | 10 sec. |
| 1 | 1152 | 10 | 12 | 15 | 24 | 51 |
| 2 | 1262 | 14 | 16 | 19 | 27 | 43 |
| 3 | 1298 | 14 | 16 | 19 | 25 | 47 |

In these tests, penetration of the molten iron is not observed, though the surface layers 3 are burned. The temperature of the lining 7 is increased by 5 degrees in average after 5 seconds and by 33 degrees in average after 10 seconds.

As being understood from the test, in a case where relatively large amount of the molten iron splashes over the protective garment 1, temperature increase of the lining 7 is relatively slow. Provided that the wearer occasionally receives the splash of molten metal, he is protected from high temperatures and penetration of the molten metal. Moreover, he has enough time to remove the garment to which the molten metal adhered because the temperature increase is relatively slow.

The protective garment 1 according to the present invention can be embodied in various versions including jackets, aprons, coats, hoods, gloves, pants, leggings, shoes and overshoes.

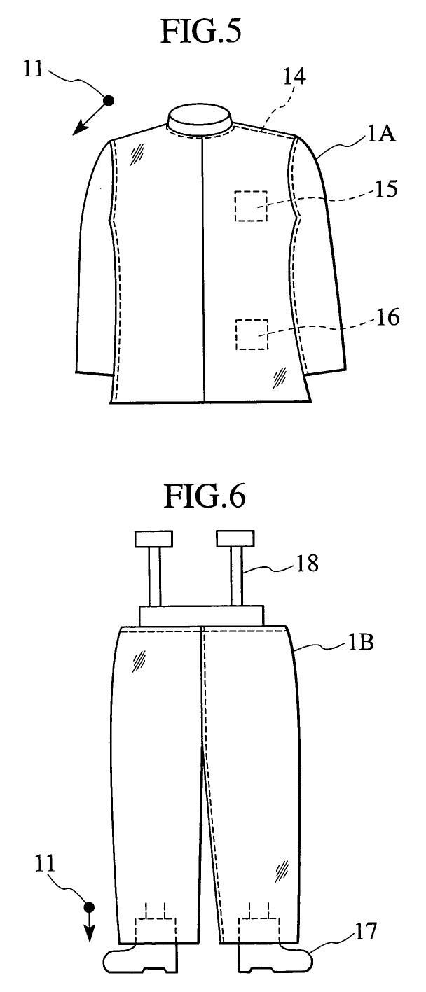

FIG. 5 shows a version of the protective garment, specifically a protective jacket 1A. Shoulder portions 14 of the protective jacket 1A are inclined from neck portions to sleeves and further inclined frontward and rearward so that splash 11 of molten metal easily flows out. The protective jacket 1A fastens in front with a zip faster and outer surface thereof is free from pockets so as to prevent the molten metal from flowing into the inside or the pocket. Pockets 15 and 16 are disposed inside of the protective jacket 1A instead.

FIG. 6 shows a protective pants 1B preferably used in combination with the protective jacket 1A. Bottoms of the protective pants 1B are configured to cover upper portions of shoes 17 thereby occasional intrusion of molten metal therein can be prevented. The protective pants 1B are provided with suspender 18 for preventing falling off.

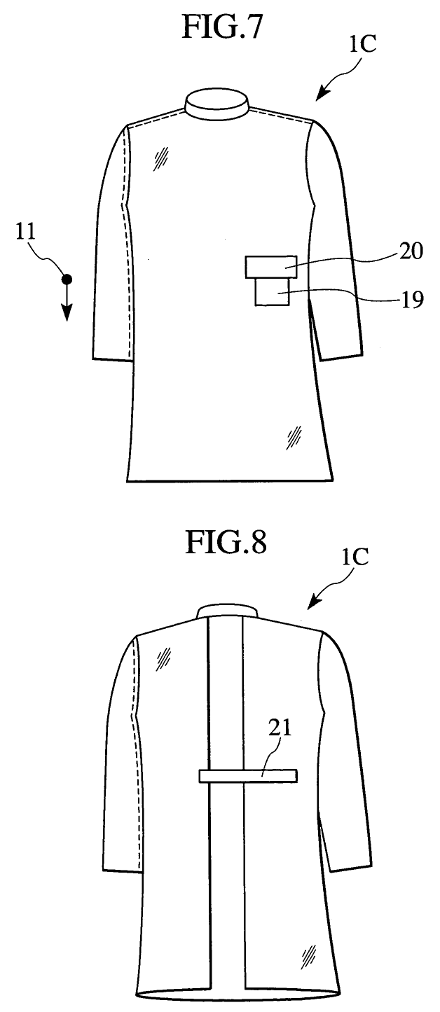

FIGS. 7 and 8 show another version of the protective garment 1, specifically a protective apron 1C. A front side of the protective apron 1C is provided with a pocket 19. For prevention of splash 11 of molten metal falling into the pocket 19, a cover 19 made of the fabric 2 is provided. The protective apron 1C fastens in rear with a hook and loop fastener 21 sold under a trade name of “VELCRO”, “MAGIC TAPE” or such. Such fastener 21 makes it easy for the wearer to fasten the rear of the protective apron 1C even when he wears protective gloves.

The protective garment 1 has high reflectivity against heat radiation, high incombustibility, high heat-resistance and good comfortableness. The protective garment 1 effectively protects the wearer from splashes of molten metal when he attends to a furnace-side work, a foundry work, a welding work and such. Moreover, the present invention can be widely applicable to protective garment for firemen and fire fighters or protective sheets for tables, floors and such.

Although the invention has been described above by reference to certain embodiments of the invention, the invention is not limited to the embodiments described above. Modifications and variations of the embodiments described above will occur to those skilled in the art, in light of the above teachings.

What is claimed is:

1. A laminated fabric for a protective garment comprising:
a surface layer of an heat-resistant fabric;
an intermediate layer of a carbon fabric;
one or more heat insulating layers of non-woven heat-resistant fabrics laminated inside of the intermediate layer; and
a lining of a heat-resistant fabric configured to be moisture-absorbing.

2. The laminated fabric of claim 1, wherein:
the heat-resistant fabric consists essentially of aramid.

3. The laminated fabric of claim 1, wherein:
the non-woven heat-resistant fabric consists essentially of aramid.

4. The laminated fabric of claim 1, wherein:
the surface layer is coated with aluminum powder.

5. The laminated fabric of claim 1, wherein:
the carbon fabric is a carbonization product of a fabric of acrylic fiber.

6. The laminated fabric of claim 5, wherein:
the carbon fabric is heat-resistant against 1500° C.

7. The laminated fabric of claim 1, wherein:
total thickness of the heat insulating layers and the lining is 2 mm or greater.

8. A protective garment for protection against molten metals comprising:
a laminated fabric including;
a surface layer of an heat-resistant fabric;
an intermediate layer of a carbon fabric;
one or more heat insulating layers of non-woven heat-resistant fabrics laminated inside of the intermediate layer; and
a lining of a heat-resistant fabric configured to be moisture-absorbing.

9. The protective garment of claim 8, wherein:
the heat-resistant fabric consists essentially of aramid.

10. The protective garment of claim 8, wherein:
the non-woven heat-resistant fabric consists essentially of aramid.

11. The protective garment of claim 8, wherein:
the surface layer is coated with aluminum powder.

12. The protective garment of claim 8, wherein:
the carbon fabric is a carbonization product of a fabric of acrylic fiber.

13. The protective garment of claim 12, wherein:
the carbon fabric is heat-resistant against 1500° C.

14. The protective garment of claim 8, wherein:
total thickness of the heat insulating layers and the lining is 2 mm or greater.
